(19) United States
(12) Patent Application Publication
(10) Pub. No.: US 2008/0052261 A1
(43) Pub. Date: Feb. 28, 2008

(54) Method for block level file joining and splitting for efficient multimedia data processing

(76) Inventor: Moshe Valenci, Jerusalem (IL)

Correspondence Address: INTEL CORPORATION;c/o INTELLEVATE, LLC, P.O. BOX 52050, MINNEAPOLIS, MN, 55402, US

(21) Appl. No.: 11/473,569

(22) Filed: Jun. 22, 2006

(51) Int. Cl. G06F 17/30

(52) U.S. Cl. 707/1

(57) ABSTRACT

Processing data of a first file of a processing system may be accomplished by splitting the first file into the first file and another file at the location of a split offset without copying the files; repeating the splitting of the first file a number of times using a specified split offset for each split file operation to create a plurality of files; joining the first file and a selected one of the plurality of files having desired data into the first file without copying the files; and repeating the joining of the first file and selected ones of the plurality of files to reconstruct the first file, the first file including only desired data after all join operations are completed.

### BACKGROUND

1. Field

The present invention relates generally to file systems in a processing system and, more specifically, to processing multimedia data using file joining and splitting operations.

2. Description

Generation of large multimedia files has become commonplace. In some streaming media applications, huge multimedia data files may be generated by capturing streaming audio and/or video from a capture device (such as a digital video camera) or by receiving audio and/or video data over a communications medium. In one example, a personal video recorder (PVR) may create a streaming Motion Picture Experts Group (MPEG) file from a television (TV) tuner device. The rate of data capture may vary from 1.15 Mbps to 9.5 Mbps or more. The size of such streaming media files may be in the range of 700 MB to 4 GB (or more) for approximately one hour of a TV program, depending on stream quality. These files are typically stored on a storage device in the PVR or on another processing system.

Users often want to be able to edit these huge files. For example, when a TV program is recorded on the PVR's storage device, the user may want to delete the commercials or erase portions of the program that the user has already viewed. To support this activity, common reconstruction tools (also called “stripping” tools) process the streamed media files and remove the unwanted sections by creating a new file that includes only the desired content. This processing typically includes creating a new output file with a restructured header of the streaming media file, copying selected Group of Pictures (GOP) frames (i.e., I, B, or P frames for MPEG data streams) from these files to the newly created output file, and optionally refining the transition between remaining sections.

However, such editing is very slow because of the extensive file copying involved, and is very inefficient in terms of storage because even removing small parts of a large multimedia file results in large file copy operations. Thus, more efficient techniques are desired.

### BRIEF DESCRIPTION OF THE DRAWINGS

The features and advantages of the present invention will become apparent from the following detailed description of the present invention in which:

FIG. 1 is a diagram illustrating a file node and data blocks according to an embodiment of the present invention;

FIG. 2 is a diagram illustrating joining files according to an embodiment of the present invention;

FIG. 3 is a diagram illustrating splitting a file according to an embodiment of the present invention;

FIG. 4 is a diagram illustrating a file node and data blocks after a file split according to an embodiment of the present invention;

FIG. 5 is a diagram illustrating a software stack according to an embodiment of the present invention;

FIG. 6 is a flow diagram of a data processing operation according to an embodiment of the present invention;

FIG. 7 is a diagram of an example of splitting a file according to an embodiment of the present invention; and

FIG. 8 is a diagram of an example of joining files according to an embodiment of the present invention.

### DETAILED DESCRIPTION

Embodiments of the present invention comprise new elementary file system operations that provide for the fast and efficient reconstruction of large data files. These file system operations may be supported by a file system driver or an operating system (OS) of a processing system. In at least one embodiment, the data files comprise multimedia data in a format such as MPEG-2 or MPEG-4, although other types of data and other formats may also be used.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

Efficient streaming media file reconstruction (or other data file manipulation operations) should provide for the elimination of unwanted sections of data (such as the prolog, epilog, or internal sections (such as commercial content), for example). In embodiments of the present invention, these file system operations are designed to have a minimal copy overhead, while performing only necessary block management operations. These block management operations may be related to the file system allocation tables used by the OS.

The file system architecture of an OS usually supports at least a basic set of operations. For example, the file system includes procedures for creating, opening, and closing files for reading and writing purposes, reading and writing files at specific offsets, and changing file access permissions based on user-specified access control list (ACL) policies.

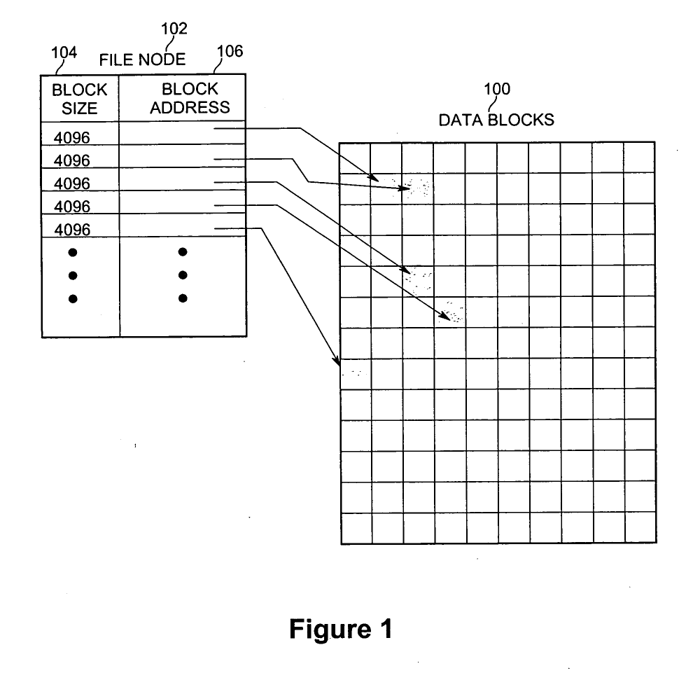

A file system includes a plurality of files, each file having one or more blocks of data, each block of data having one or more bytes of data. The OS manages the files by assigning a file node data structure to each file. The file node specifies at least the starting addresses in memory of the blocks making up the file. This can be seen in FIG. 1. FIG. 1 is a diagram illustrating a file node and data blocks according to an embodiment of the present invention. A storage device of a processing system includes a plurality of data blocks 100. Each data block may include at most a predetermined number of bytes. In this example, a data block includes a maximum of 4096 bytes, although other sizes may also be used. In embodiments of the present invention, file node 102 includes a plurality of block size 104 and block address 106 fields as shown. Each block of the file has a corresponding block size and block address pair as an entry in the file node for the file. The block size field defines that portion of the block currently being used out of the maximum size specified for blocks in the file system. In some prior art systems, the block size is assumed to be the same for all blocks of the file and is included only once for the entire file node. In contrast, in embodiments of the present invention, the block size field is included for each block and may be different for each block depending on how much data is stored in the block. The block address field specifies the starting address of the block in the address space of the storage system. In this simple example, the file comprises five blocks distributed in memory as shown. The blocks of a file may or may not be contiguous in memory, and there may be any number of blocks in a file.

In embodiments of the present invention, up to four new elementary file operations may be provided. These operations include joining files, splitting a file, getting file statistics, and compacting a file. These operations may be performed by an OS, by a file system driver or plug-in software accessible by the OS, or another entity in a processing system. The data stored in files to be joined or split must be in the same format (e.g., if the data comprises multimedia data, the data must be in the same resolution, frame rate, etc.).

A Join Files operation joins two files. In one embodiment, a general command description is:

```
int FileSystem_JoinFile (
    [in] string Filename 1,
    [in] string Filename 2
);
```

In a successful Join File operation, all of the data in the file identified by Filename2 may be appended to the file identified by Filename1, and Filename2 may be deleted from the file system. Filename1 remains with the data for both of the original files. During the Join File operation, the data blocks are not moved or copied. The two files must have the same file permissions for the command to succeed. In one embodiment, an extra block of data may be freed (with minimal copy overhead) as the join point may allow for compacting of two blocks which are not used entirely into a single block. Thus, the number of blocks in the remaining file is the same as the sum of the number of blocks of the two starting files, or the sum reduced by one.

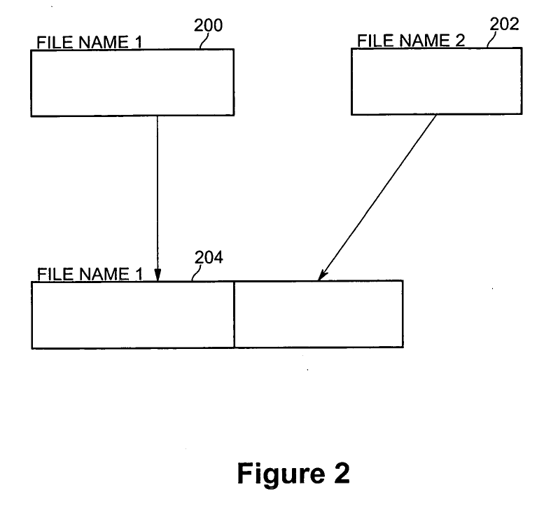

FIG. 2 is a diagram illustrating logically joining files according to an embodiment of the present invention. In this example, a first file, identified as File Name 1 200 is to be joined with a second file, identified as File Name 2 202. The resulting file is identified as File Name 1 204, and includes the data of File Name 1 and File Name 2. During this join operation, the data for the two files is not moved or copied. Instead, the file nodes representing the files in the file system are edited to reflect performance of the join operation. In this example, the file node for File Name 1 is amended by adding the block size and block address pairs for all of the blocks of File Name 2. Thus, future accesses to File Name 1 (via its file node) may reference the data from the original File Name 1 and also the data from File Name 2.

A Split File operation splits a file into two files. In one embodiment, a general command description is:

```
int FileSystem_SplitFile (
  [in] string Filename1,
  [in] int64 SplitOffset,
  [in] string Filename2
);
```

In a successful Split File operation, the filed identified by Filename1 may be trimmed to the length of SplitOffset bytes, and the remaining data is associated with a new file object identified by Filename2. This file (Filename2) inherits the security permissions of Filename1. In one embodiment, an extra block may be created (with minimal copy overhead) because the split point may result in a block being resized, and the remainder of the split block's data will be stored in a new block.

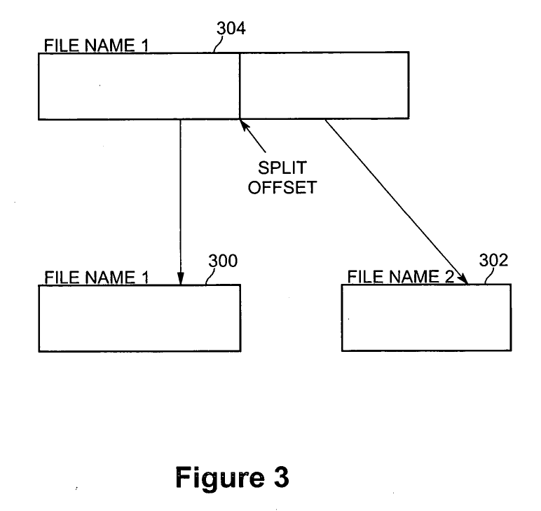

FIG. 3 is a diagram illustrating logically splitting a file according to an embodiment of the present invention. A file 304 identified by Filename1 is to be split into two parts. A first part, from the beginning of the file up to and including a byte specified by SplitOffset, remains in Filename1 300. The remaining portion of the data block specified by SplitOffset, and all of the data blocks after the location specified by SplitOffset, become associated with a new file called Filename2 302. The data in original Filename1 is not copied or moved. Instead, the block sizes and block addresses in the file nodes are edited to reflect the file split. Specifically, the block size and block address pairs for complete blocks no longer in Filename1 are moved from the file node for Filename1 to the file node for Filename2. If there is a partial block, the block size and block address pairs in each of the file nodes is modified to reflect the split of a block between two files.

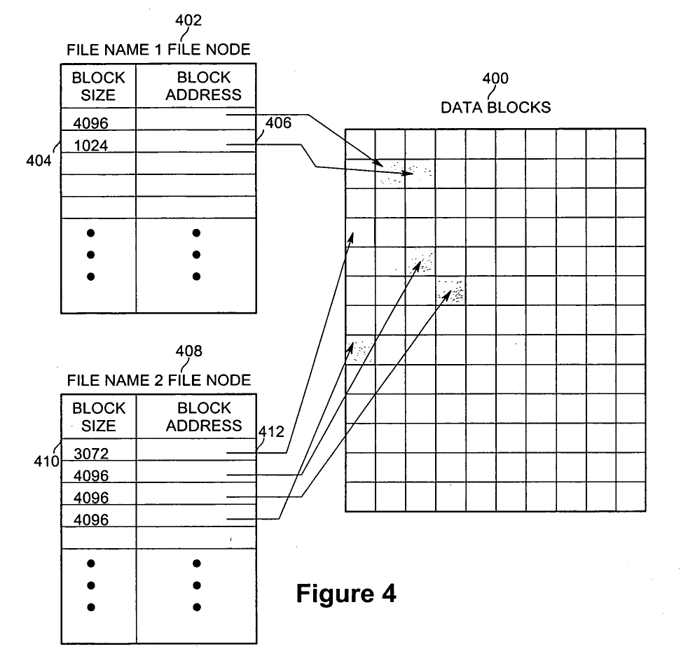

FIG. 4 is a diagram illustrating a file node and data blocks after a file split according to an embodiment of the present invention. The data blocks 400 for the original file are not moved in memory. The file node 402 for Filename1 is modified to reflect the file split. In particular, the block size entry 404 for the data block determined by SplitOffset is modified. In this example, SplitOffset referenced an offset of 5120 bytes from the start of the file, resulting in a partial block of 1024 bytes. The starting block address 406 for this partial block does not change. A new file node 408 may be created for the second file (Filename2). A new block is allocated to store the remainder of the block where the split occurred. The remaining data from the partial block may be copied into the new block. The first entry in the new file node includes a block size 410 (3072 in this example) and block address 412 of the newly allocated block. The remaining entries of file node 408 include the block sizes and block addresses of the remaining blocks of the original file (now referred to as Filename2) copied from the file node for Filename1.

A Get File Statistics operation traverses the file node for a specified file and computes the overhead involved in divided block structures. In one embodiment, a general command description is:

```
Int FileSystem_GetFileStatistics (
    [in] string Filename 1,
    [out] int64 CompleteBlocks,
    [out] int64 DividedBlocks
);
```

The Get File Statistics function determines the number of complete blocks (blocks fully used) and the number of divided blocks (blocks partially used) by traversing the block size fields of the file's file node. The ratio of the values indicates the efficiency of the file stored on a storage medium.

A Compact File operation traverses the file node for the file and compacts the file to use complete blocks. In one embodiment, a general command description is:

Int FileSystem_CompactFile (
[in] string Filename
);

The Compact File operation reorganizes the file to eliminate most partial data blocks. In one embodiment, this operation eliminates all partial blocks except for one partial block. Since this command may involve extra processing (e.g., data copies), the OS or the file system driver may call the Get File Statistics command to determine if the compaction is desirable. The compaction may be performed during idle OS phases when the user is not performing other processing. Any suitable one of many known algorithms for garbage collection/compaction may be used.

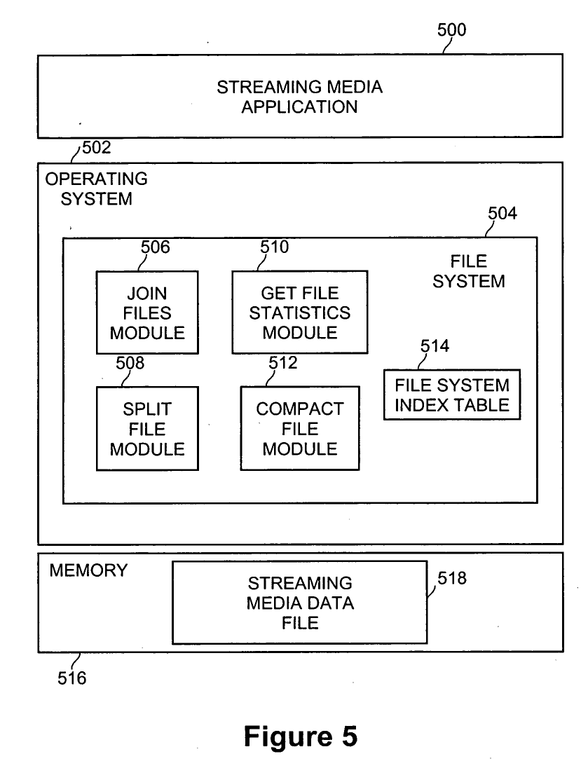

FIG. 5 is a diagram illustrating a software stack according to an embodiment of the present invention. A streaming media application 500 may be executed by a processing system (not shown) and interact with operating system (OS) 502. The OS includes a file system 504. The file system exports application programming interfaces (APIs) for a join files module 506, a split file module 508, a get file statistics module 510, and a compact file module 512. The streaming media application may call these APIs via the OS to perform the join files, split file, get file statistics, and compact file operations. The file system also includes a file system index table 514. The file system index table includes a plurality of file nodes, one for each current file in the file system. Streaming media data may be stored in a streaming media data file 518, previously created and opened by the file system. This file may reside in a memory 516 of the processing system.

A user of the processing system may direct the streaming media application to modify a streaming media data file by stripping out unwanted sections. Using the file operations described above, the streaming media application may strip out the unwanted sections in a fast and efficient manner.

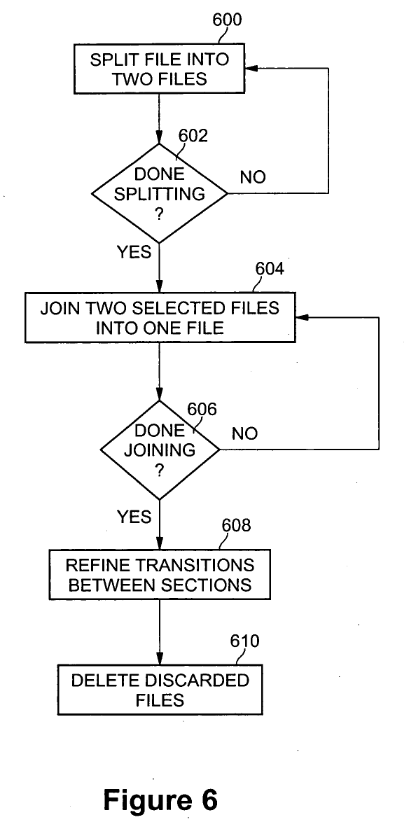

FIG. 6 is a flow diagram of a data processing operation according to an embodiment of the present invention. This data processing operation filters a streaming multimedia data file 518 according to known file offsets. It is assumed that the user has interacted with the streaming media application 500 to indicate which sections of the file are to be discarded, and which sections are desired to be retained. The sections may be specified by file offsets.

At block 600, a file may be split into two files using the above-described Split File operation based on a specified Split Offset. At block 602, a check is made to determine if any more splitting of the file needs to be performed. If more splitting is required, block 600 is repeated. In this way, the file may be split into as many sections as is needed to fulfill the user's directions regarding removing unwanted sections of the file.

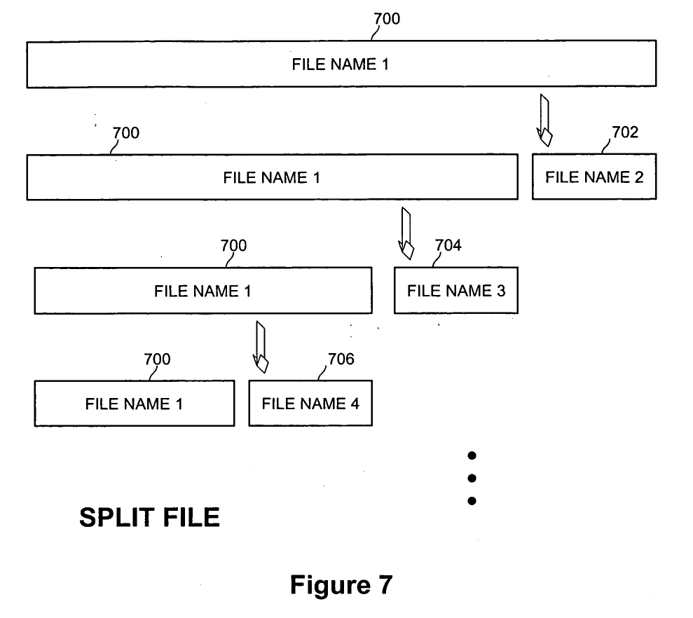

FIG. 7 is a diagram of an example of splitting a file according to an embodiment of the present invention. In this simple example, a file 700 designated by File Name 1 may first be split into two sections, a first section 700 identified as File Name 1, and a second section 702 identified as File Name 2. The original file (File Name 1) may then be split again to include a first section 700 still identified as File Name 1, and a third section 704 identified as File Name 3. Next, the original file (File Name 1) may be split again, a first section 700 still identified as File Name 1, and a fourth section 706 identified as File Name 4. These steps may be repeated as needed, each split operation using a specified split offset.

In this manner, a file may be efficiently and quickly split into a number of separate files according to user inputs and specified Split Offsets. Each split file operation results in a new file node being created, but does not incur a data copy cost (other than possibly a single partial block copy). The result is a plurality of files, each file storing a section of the original file. Some of the sections may be unwanted by the user, but other sections may include data desired by the user and to be retained.

Returning to FIG. 6, if no more splitting of files is necessary at block 602, processing continues with block 604. At this block, two selected files having desired data may be joined into a single file using the Join Files operation. The files may be selected by the streaming media application to build the resulting output file including only those sections the user wants. At block 606, a check is made to determine if more files need to be joined. If so, block 604 may be repeated. This processing may continue until the remaining file includes all of the desired data of the original file, but none of the unwanted sections. Each join operation results in a file node being deleted from the file system, but does not incur a data copy cost.

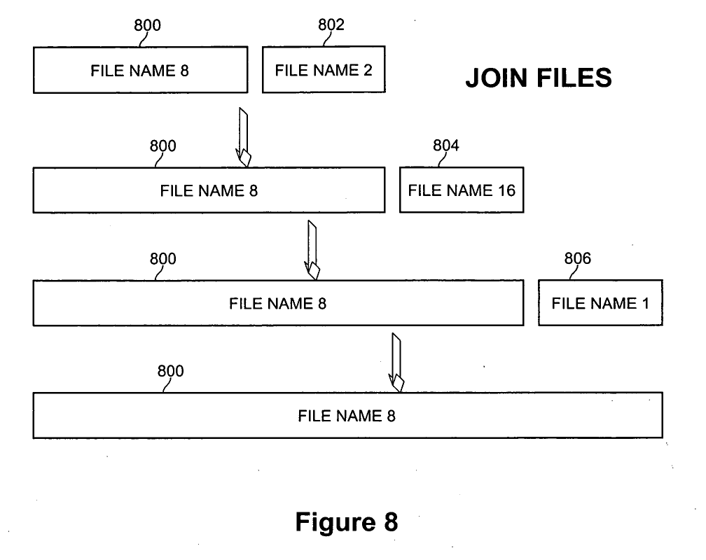

FIG. 8 is a diagram of an example of joining files according to an embodiment of the present invention. First, sections of data stored in file 800 identified as File Name 8, and in file 802 identified as File Name 2 are joined. The result is a file 800 identified as File Name 8. Next, another file may be joined with File Name 8. In this example, a file 804 identified as File Name 16 is joined with the file 800 identified as File Name 8. This may be repeated again with a file 806 identified as File Name 1. These actions may be repeated as necessary. When the join operations are completed, the file 800 identified as File Name 8 includes all of the desired data sections.

Returning back to FIG. 6, once all join operations are complete, further processing may be performed. For example, at block 608, transitions between sections of the file may be refined or modified in some way to provide for a better viewing experience for the user. When the multimedia data format is MPEG-2 or MPEG-4, the transitions may be refined by adding a Key-frame (also known as an l-frame) to the beginning of each second section being joined. Other refinements, depending on the multimedia data format, are envisioned. Finally, at block 610, the files for the discarded sections may be deleted.

Thus, a multimedia data file may be efficiently processed using the file operations described herein to filter out unwanted sections without incurring large data copy costs. In one simulation, a 4 GB MPEG-2 data file was stripped using an embodiment of the present invention in approximately 5% of the time as would be used by an existing method. This significant difference is achieved because of the fact that the processing system is not busy with copying the data back and forth, but merely rearranges the logical structure of the file nodes in the File System Index Table.

Although the following operations may be described as a sequential process, some of the operations may in fact be performed in parallel or concurrently. In addition, in some embodiments the order of the operations may be rearranged.

The techniques described herein are not limited to any particular hardware or software configuration; they may find applicability in any computing or processing environment. The techniques may be implemented in hardware, software, or a combination of the two. The techniques may be implemented in programs executing on programmable machines such as mobile or stationary computers, personal digital assistants, set top boxes, PVRs, TVs, cellular telephones and pagers, and other electronic devices, that each include a processor, a storage medium readable by the processor (including volatile and non-volatile memory and/or storage elements), at least one input device, and one or more output devices. Program code is applied to the data entered using the input device to perform the functions described and to generate output information. The output information may be applied to one or more output devices. One of ordinary skill in the art may appreciate that the invention can be practiced with various computer system configurations, including multiprocessor systems, minicomputers, mainframe computers, and the like. The invention can also be practiced in distributed computing environments where tasks may be performed by remote processing devices that are linked through a communications network.

Each program may be implemented in a high level procedural or object oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine accessible medium having stored thereon instructions that may be used to program a processing system or other electronic device to perform the methods. The term “machine accessible medium” used herein shall include any medium that is capable of storing or encoding a sequence of instructions for execution by a machine and that cause the machine to perform any one of the methods described herein. The term “machine accessible medium” shall accordingly include, but not be limited to, solid-state memories, optical and magnetic disks, and a carrier wave that encodes a data signal. Furthermore, it is common in the art to speak of software, in one form or another (e.g., program, procedure, process, application, module, logic, and so on) as taking an action or causing a result. Such expressions are merely a shorthand way of stating the execution of the software by a processing system cause the processor to perform an action of produce a result.

What is claimed is:

1. A method of processing data of a first file of a processing system comprising:
splitting the first file into the first file and another file at the location of a split offset without copying the files;
repeating the splitting of the first file a number of times using a specified split offset for each split file operation to create a plurality of files;
joining the first file and a selected one of the plurality of files having desired data into the first file without copying the files; and
repeating the joining of the first file and selected ones of the plurality of files to reconstruct the first file, the first file including only desired data after all join operations are completed.

2. The method of claim 1, wherein the split offset comprises the number of bytes from the start of the first file to the location where the split occurs.

3. The method of claim 1, further comprising deleting files generated by the split file operations that are not used in the join file operations.

4. The method of claim 1, wherein each file of the processing system comprises a plurality of blocks of storage, and is represented by a file node having a plurality of block size and block address pairs, a pair for each block of the file, the block size specifying the size of the data being used in the block and the block address specifying the starting address of the block in storage.

5. The method of claim 4, wherein splitting the first file into the first file and another file comprises associating data of the first file after the split offset with the other file by creating a file node for the other file, the file node for the other file specifying block size and block address pairs for each block of data after the split offset to the end of the first file, and modifying the block size and block address pairs of the file node for the first file to denote that the associated data is no longer part of the first file.

6. The method of claim 4, wherein joining the first file and the selected one of the plurality of files comprises appending block size and block address pairs from the file node of the selected file to the file node of the first file, and deleting the file node of the selected file.

7. The method of claim 6, wherein the data comprises multimedia data and further comprising refining transitions between sections of the reconstructed first file.

8. The method of claim 6, wherein the multimedia data comprises at least one of MPEG-2 and MPEG-4 data received by a streaming media application.

9. The method of claim 4, further comprising determining a number of complete blocks and a number of divided blocks for the first file.

10. The method of claim 4, further comprising compacting the first file to eliminate all partially used blocks except at most one partially used block.

11. An article comprising: a machine accessible medium containing instructions, which when executed, result in processing data of a first file of a processing system by
splitting the first file into the first file and another file at the location of a split offset without copying the files;
repeating the splitting of the first file a number of times using a specified split offset for each split file operation to create a plurality of files;
joining the first file and a selected one of the plurality of files having desired data into the first file without copying the files; and
repeating the joining of the first file and selected ones of the plurality of files to reconstruct the first file, the first file including only desired data after all join operations are completed.

12. The article of claim 11, wherein the split offset comprises the number of bytes from the start of the first file to the location where the split occurs.

13. The article of claim 11, further comprising instructions for deleting files generated by the split file operations that are not used in the join file operations.

14. The article of claim 11, wherein each file of the processing system comprises a plurality of blocks of storage, and is represented by a file node having a plurality of block size and block address pairs, a pair for each block of the file, the block size specifying the size of the data being used in the block and the block address specifying the starting address of the block in storage.

15. The article of claim 14, wherein instructions for splitting the first file into the first file and another file comprise instructions for associating data of the first file after the split offset with the other file by creating a file node for the other file, the file node for the other file specifying block size and block address pairs for each block of data after the split offset to the end of the first file, and modifying the block size and block address pairs of the file node for the first file to denote that the associated data is no longer part of the first file.

16. The article of claim 14, wherein instructions for joining the first file and the selected one of the plurality of files comprise appending block size and block address pairs from the file node of the selected file to the file node of the first file, and deleting the file node of the selected file.

17. The article of claim 16, wherein the data comprises multimedia data and further comprising refining transitions between sections of the reconstructed first file.

18. The article of claim 16, wherein the multimedia data comprises at least one of MPEG-2 and MPEG-4 data received by a streaming media application.

19. The article of claim 14, further comprising instructions for determining a number of complete blocks and a number of divided blocks for the first file.

20. The article of claim 14, further comprising instructions for compacting the first file to eliminate all partially used blocks except at most one partially used block.

21. A processing system comprising:
a streaming media application to obtain multimedia data;
a memory to store the multimedia data in a first file; and
a file system to manage files stored in the memory, the file system including
a split file module to split the first file into the first file and another file at the location of a split offset without copying the files; and to repeat the splitting of the first file a number of times using a specified split offset received from the streaming media application for each split file operation to create a plurality of files; and
a join files module to join the first file and a selected one of the plurality of files having desired data into the first file without copying the files; and to repeat the joining of the first file and selected ones of the plurality of files to reconstruct the first file, the first file including only desired data after all join operations are completed.

22. The processing system of claim 21, wherein the split offset comprises the number of bytes from the start of the first file to the location where the split occurs.

23. The processing system of claim 21, wherein the join files module is adapted to delete files generated by the split file operations that are not used in the join file operations.

24. The processing system of claim 21, wherein each file of the processing system comprises a plurality of blocks of storage, and is represented by a file node having a plurality of block size and block address pairs, a pair for each block of the file, the block size specifying the size of the data being used in the block and the block address specifying the starting address of the block in storage.

25. The processing system of claim 24, wherein the split file module is adapted to split the first file into the first file and another file by associating data of the first file after the split offset with the other file by creating a file node for the other file, the file node for the other file specifying block size and block address pairs for each block of data after the split offset to the end of the first file, and modifying the block size and block address pairs of the file node for the first file to denote that the associated data is no longer part of the first file.

26. The processing system of claim 24, wherein the join files module is adapted to join the first file and the selected one of the plurality of files by appending block size and block address pairs from the file node of the selected file to the file node of the first file, and deleting the file node of the selected file.

27. The processing system of claim 26, wherein the streaming media application is adapted to refine transitions between sections of the reconstructed first file.

28. The processing system of claim 26, wherein the multimedia data comprises at least one of MPEG-2 and MPEG-4 data obtained by a streaming media application.

29. The processing system of claim 24, wherein the file system further comprises a get file statistics module to determine a number of complete blocks and a number of divided blocks for the first file.

30. The processing system of claim 24, wherein the file system further comprises a compact file module to compact the first file to eliminate all partially used blocks except at most one partially used block.
